(19) United States
(12) Patent Application Publication
(10) Pub. No.: US 2007/0211718 A1
(43) Pub. Date: Sep. 13, 2007

(54) Method of and apparatus for converting data stream format and method of and apparatus for recording data stream using the method and apparatus

(75) Inventors: Hee-Beom Kang, Hwaseong-si (KR); Choon-sik Jung, Hwaseong-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/708,069

(22) Filed: Feb. 20, 2007

(30) Foreign Application Priority Data
Mar. 10, 2006 (KR) 10-2006-0022725

(51) Int. Cl. H04L 12/56; H04J 3/16

(52) U.S. Cl. 370/389; 370/466

(57) ABSTRACT

A method of and apparatus for converting a program stream (PS) into a transport stream (TS) and a method of and apparatus for recording a data stream using the method and apparatus are provided. The method for converting the PS includes extracting a system clock reference (SCR) and a program mux rate; extracting a stream identifier (ID) from a packetized elementary stream (PES) packet header; identifying a data type of PES packets using the stream identifier (ID); dividing the PES packets according to a payload size of a TS packet if the identified data type is video or audio data; generating consecutive TS packets by adding a TS pack header to each of the divided PES packets; and setting a program clock reference (PCR) of an adaptation field included in a TS packet header of the first generated TS packet equal to the extracted SCR.

### CROSS-REFERENCE TO RELATED PATENT APPLICATION

This application claims the benefit of Korean Patent Application No. 10-2006-0022725, filed on Mar. 10, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to a method of and apparatus for converting a data stream format, and more particularly, to a method of and apparatus for converting a program stream (PS) into a transport stream (TS) and a method of and apparatus for recording a data stream using the method and apparatus.

2. Description of the Related Art

Video data and audio data generated according to a data compression standard such as the moving picture experts group (MPEG) standard are multiplexed after being divided into data of predetermined sizes for transmission or storage, respectively. Multiplexing in an MPEG system involves receiving an elementary stream (ES) obtained from bitstreams compressed by a media encoder and generating packetized elementary stream (PES) packets. Once the PES packets are generated, a program stream (PS) or a transport stream (TS) is generated by multiplexing the generated PES packets. For the PS, a plurality of PES packets are grouped to form a pack. For the TS, a PES packet is sub-divided to form a plurality of TS packets. The PS has a variable-length obtained by multiplexing PES packets and is usually used to record data in a storage medium such as a digital versatile disc (DVD) or a high-definition (HD)-DVD in an errorless environment. The TS packet has a fixed length of 188 bytes. The TS packet is used to multiplex a plurality of programs in an error-prone environment such as broadcasting.

At present, data is stored in a storage medium such as a DVD or an HD-DVD using a PS. Recently released devices for receiving and storing digital broadcasting record and store a TS in a predetermined storage medium, e.g., hard disk drives (HDDs) or Blu-ray disks (BDs). Thus, in order for an apparatus for reproducing data in a TS format to process contents recorded in a PS format such as contents of a DVD or an HD-DVD, a PS should be first converted into a TS.

FIG. 1 is a block diagram of a related data stream format converter 100 that converts a PS into a TS.

Referring to FIG. 1, the data stream format converter 100 includes a PS demultiplexer 110 and a TS multiplexer 120.

The PS demultiplexer 110 includes a PES extractor 111 and an ES generator 112. The PES extractor 111 generates a PES stream including a sequence of PES packets obtained by demultiplexing an input PS. The ES generator 112 generates an ES by depacketizing the generated PES stream.

The TS multiplexer 120 includes a PES packetizer 121, a TS packetizer 122, and a system time clock 123. The PES packetizer 121 receives the ES generated by the PS demultiplexer 110 and constructs a PES header and a payload corresponding to information of the PES header by performing an inverse process to that performed by the ES generator 112, thereby generating a PES packet. The TS packetizer 122 sub-divides the PES packet to generate a TS packet of 188 bytes. The PES packetizer 121 adds a presentation time stamp (PTS) and a decoding time stamp (DTS) to the PES header when generating the PES packet. At this time, values indicated by the PTS and the DTS are expressed based on the same time reference, i.e., a system time clock (STC) 123. To synchronize reference clocks of an encoder and a decoder in an MPEG system, the TS packetizer 122 records a program clock reference (PCR) in a header of the generated TS packet.

As such, to convert a PS into a TS according to the related art, demultiplexing is performed on the PS. Moreover, instead of using time information included in the PS, time information for synchronization is additionally generated during re-multiplexing and is added to a header of a TS packet.

### SUMMARY OF THE INVENTION

The present invention provides a method of and apparatus for converting a data stream format, in which an MPEG-2 PS is converted into an MPEG-2 TS, and a method of and apparatus for recording a data stream using the method and apparatus.

The present invention also provides a method of and apparatus for converting a data stream format, in which the amount of computation used for conversion of the data stream format is reduced by skipping PES packetization and ES generation during conversion of a PS into a TS and by using a time reference needed for the TS that is calculated using time information included in the PS, and a method of and apparatus for recording a data stream using the method and apparatus.

According to an aspect of the present invention, there is provided a method of converting a data stream format, in which a program stream (PS) is converted into a transport stream (TS). The method includes extracting a system clock reference (SCR) and a program mux rate from a pack header included in a pack of the PS, extracting a stream identifier (ID) from a packetized elementary stream (PES); identifying a data type of PES packets included in the pack using the stream ID, dividing the PES packets according to a payload size of a TS packet if the identified data type is video or audio data, generating consecutive TS packets by adding a TS pack header to each of the divided PES packets; and setting a program clock reference (PCR) of an adaptation field included in a TS packet header of a first generated TS packet, among the consecutive TS packets, equal to the extracted SCR.

According to another aspect of the present invention, there is provided an apparatus for converting a data stream format, in which a program stream (PS) is converted into a transport stream (TS). The apparatus includes a PS analyzing unit, a packetized elementary stream (PES) packet type identifying unit, a PES packet dividing unit, and a TS packet generating unit. The PS analyzing unit extracts a system clock reference (SCR) and a program mux rate from a pack header included in a pack of the PS. The PES packet type identifying unit identifies a data type of PES packets included in the pack using a stream identifier (ID) extracted from a PES packet header included in the pack. The PES packet dividing unit divides the PES packets according to a payload size of a TS packet if the identified data type is video or audio data. The TS packet generating unit generates consecutive TS packets by adding a TS pack header to each of the divided PES packets and sets a program clock reference (PCR) of an adaptation field included in a TS packet header of a first generated TS packet, among the consecutive TS packets, equal to the extracted SCR.

According to another aspect of the present invention, there is provided a method of converting a data stream format, in which a program stream (PS) is converted into a transport stream (TS). The method includes extracting a program mux rate from a pack header included in a pack of the PS, calculating a TS arrival time stamp (ATS) offset indicating a time difference between TS packets using a pack size and the extracted program mux rate, dividing PES packets included in the pack according to a payload size of a TS packet; generating consecutive TS packets by adding a TS pack header to each of the divided PES packets; and inserting a TS packet including a fixed program clock reference (PCR) packet identifier (PID) and a PCR calculated using the TS ATS offset, instead of a null packet inserted for synchronization between the pack and the consecutive TS packets.

According to another aspect of the present invention, there is provided an apparatus for converting a data stream format, in which a program stream (PS) is converted into a transport stream (TS). The apparatus includes a PS analyzing unit, a TS arrival time stamp (ATS) offset calculating unit, and a TS packet generating unit. The PS analyzing unit extracts a program mux rate from a pack header included in a pack of the PS. The TS ATS offset calculating unit calculates a TS ATS offset indicating a time difference between TS packets using a pack size and the extracted program mux rate. The TS packet generating unit divides PES packets included in the pack according to a payload size of a TS packet, generates consecutive TS packets by adding a TS pack header to each of the divided PES packets, and inserts a TS packet including a fixed program clock reference (PCR) packet identifier (PID) and a PCR calculated using the TS ATS offset, instead of a null packet inserted for synchronization between the pack and the consecutive TS packets.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art data stream format converter that converts a PS into a TS;

FIG. 2 illustrates the data structure of an MPEG-2 PS;

FIG. 3 illustrates the data structure of an MPEG-2 TS;

FIG. 4 is a flowchart illustrating a method of converting a data stream format according to an exemplary embodiment of the present invention;

FIG. 5 is a block diagram of an apparatus for converting a data stream format according to an exemplary embodiment of the present invention;

FIGS. 6 through 8 illustrate examples of conversion of a pack of a PS into TS packets according to an exemplary embodiment of the present invention;

FIG. 9 is a flowchart illustrating a method of converting a data stream format according to another exemplary embodiment of the present invention;

FIG. 10 is a block diagram of an apparatus for converting a data stream format according to another exemplary embodiment of the present invention; and

FIGS. 11 through 13 illustrate examples of conversion of a pack of a PS into TS packets according to another exemplary embodiment of the present invention.

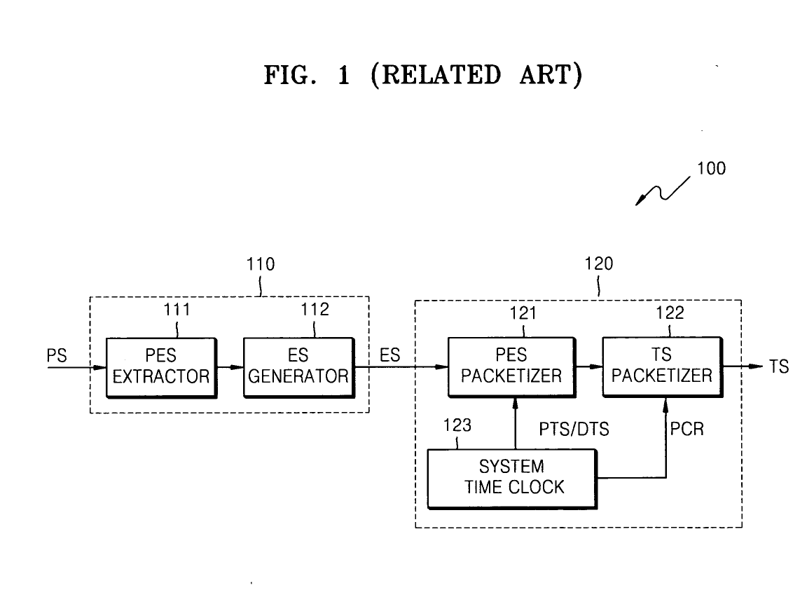

### DETAILED DESCRIPTION OF EXEMPLARY EMBODIMENTS OF THE INVENTION

Hereinafter, exemplary embodiments of the present inventive concept will be described in detail with reference to the accompanying drawings.

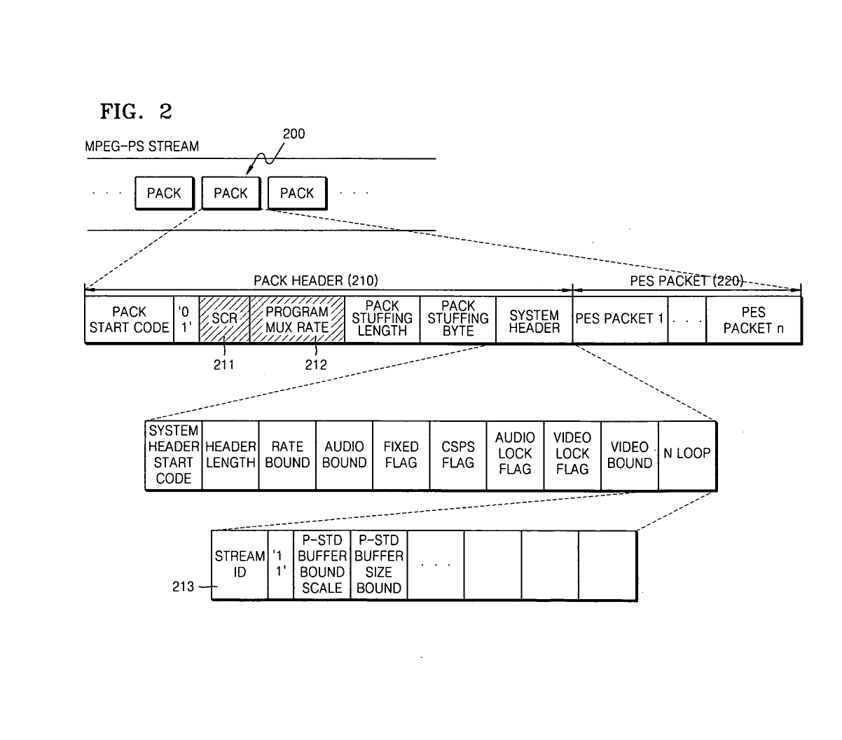

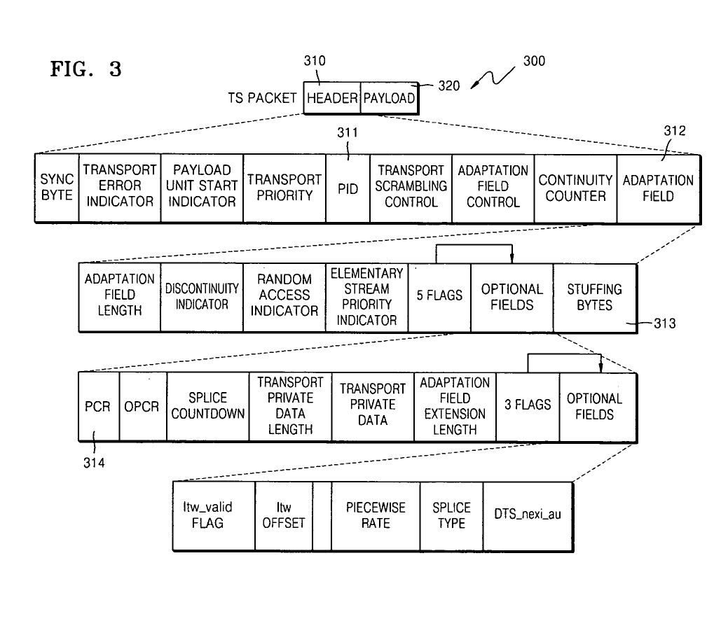

To facilitate understanding of the present invention, the data structures of an MPEG-2 program stream (PS) and an MPEG-2 transport stream (TS) will be described with reference to FIGS. 2 and 3.

FIG. 2 illustrates the data structure of an MPEG-2 PS. The PS is composed of a plurality of packs 200 and has a variable length. Each of the packs 200 includes a pack header 210 and a plurality of PES packets 220. In general, in a storage medium storing data in a PS format, such as a DVD or an HD-DVD, each pack has a size of, for example, 2 KB. The pack size is generally based on a sector size. The packet header 210 includes a pack start code field, a “11” field, a system clock reference (SCR) field 211, a program mux rate field 212, a pack stuffing length field, a pack stuffing byte field, and a system header field. The system header field includes a system header start code field, a header length field, a rate bound field, an audio bound field, a fixed flag field, a CSPS field, an audio lock flag field, a video lock flag field, a video bound field, and an N loop field. The N loop field includes a stream identifier (ID) field 213, a “11” field, a P-STD buffer bound scale field, a P-STD buffer size bound field, and other fields. Each of the plurality of PES packets 220 included in the pack includes a header portion and a data portion. As will be described below, the SCR field 211, the program mux rate field 212, and the stream ID field 213, among the various fields included in the pack header 210, are used to convert a PS into a TS according to an exemplary embodiment of the present invention.

FIG. 3 illustrates the data structure of an MPEG-2 TS. In FIG. 3, the data structure of a TS packet 300 and the data structures of a header 310 and a payload 320 included in the TS packet 300 are shown. The MPEG-2 TS includes a plurality of 188-byte TS packets, each of which includes a header 310 and a payload 320. The header 310 includes a sync byte field, a transport error indictor field, a payload unit start indicator field, a transport priority field, a packet ID (PID) field 311, a transport scrambling control field, an adaptation field control field, a continuity counter field, and an adaptation field 312. The adaptation field 312 includes an adaptation field length field, a discontinuity indicator field, a random access indicator field, an elementary stream priority indicator field, a 5-flag field indicating optional fields, and a stuffing byte field 313. The optional fields include a program clock reference (PCR) field 314, an old program clock reference (OPCR) field, a splice countdown field, a transport private data length field, a transport private data field, an adaptation field extension length field, and a 3-flag field indicating optional fields. As will be described below, a value calculated using information extracted from the PS is recorded in the PID field 311 and the PCR field 314, among the various fields included in the header 310 of the TS packet 300, and the stuffing byte field 313 is used to generate a complete TS packet by supplementing incomplete PES packets if a size of PES packets is smaller than that of the payload of the TS packet.

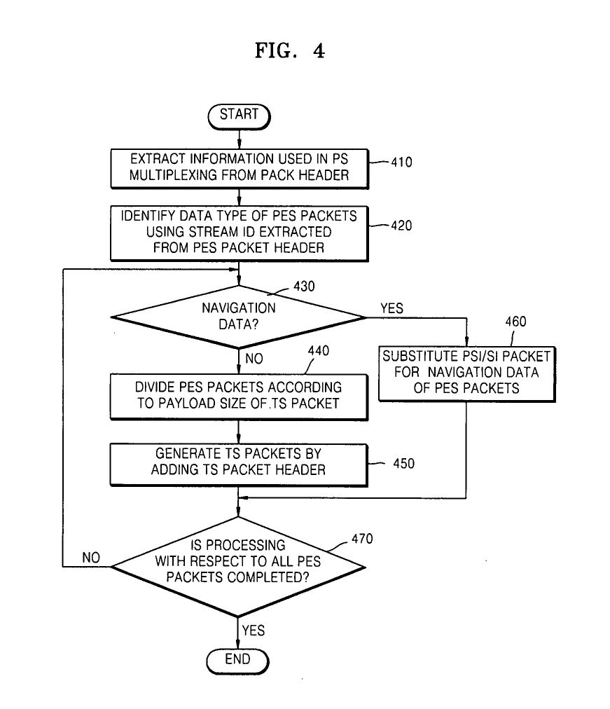

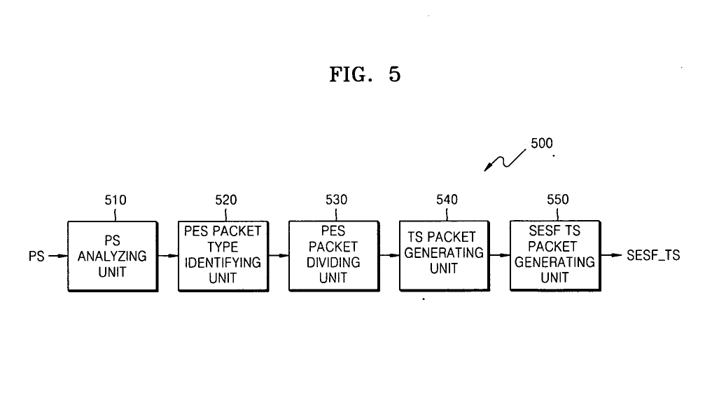

FIG. 4 is a flowchart illustrating a method of converting a data stream format according to an exemplary embodiment of the present invention, and FIG. 5 is a block diagram of an apparatus 500 for converting a data stream format according to an exemplary embodiment of the present invention.

In an exemplary embodiment of the present invention, a PS is converted into a TS for a case where the PID of a packet having a PCR (hereinafter, referred to as a PCR packet) is not specified to a certain value. Referring to FIG. 5, the apparatus 500 includes a PS analyzing unit 510, a PES packet type identifying unit 520, a PES packet dividing unit 530, a TS packet generating unit 540, and a self encode stream format (SESF) TS packet generating unit 550 for supporting an SESF TS format.

The PS analyzing unit 510 extracts information for multiplexing a PS from a pack header of a pack of the PS in operation 410. The extracted information includes an SCR and a program mux rate as illustrated in FIG. 2. The extracted SCR is used as an initial arrival time stamp (ATS) for a first source packet. If the PID of a PCR packet is not specified to a certain value, the extracted PCR can be directly used as a PCR of an adaptation field of a first TS packet for the pack. The extracted program mux rate is used to calculate an SCR offset indicating a difference between SCRs of packs included in the PS.

The PES packet type identifying unit 520 identifies the data type of PES packets included in the pack using a stream ID extracted from headers of the PES packets included in the pack in operation 420. It is determined if the data type of the PES packets is navigation data in operation 430. If the data type of the PES packets is determined to be not navigation data, i.e., video data or audio data, the PES packet dividing unit 530 divides the PES packets according to the payload size of a TS packet in operation 440. Since the payload size of a TS packet is generally 184 bytes, the PES packet dividing unit 530 may divide the PES packets included in the PS into 184-byte units.

The TS packet generating unit 540 adds a TS packet header according to a TS format to each of the divided PES packets, thereby generating consecutive TS packets in operation 450. The TS packet generating unit 540 directly uses an SCR extracted from a pack header of the PS as a PCR of an adaptation field of a header of the first generated TS packet. When the TS packet generating unit 540 generates a header of a TS packet, it determines a PID using the identified data type of the PES packets. In other words, the TS packet generating unit 540 inserts a PID indicating a video stream into a header of a TS packet if the extracted stream ID indicates a video stream. If the extracted stream ID indicates an audio stream, the TS packet generating unit 540 inserts a PID indicating an audio stream into a header of a TS packet. If the extracted stream ID indicates navigation data, the TS packet generating unit 540 inserts a PID indicating program specific information (PSI)/system information (SI) into a header of a TS packet. The navigation data may be general control information (GCI), presentation control information (PCI), or data search information (DSI). If the data type of the PES packets is identified as navigation data, the TS packet generating unit 540 inserts a PSI/SI packet to check if processing with respect to a current pack is completed, instead of processing a current PES packet, and inserts a null packet into a remaining space for synchronization between the pack of the PS and the generated TS packets in operation 460.

The TS packet generating unit 540 calculates an SCR offset indicating a difference between SCRs of packs included in the PS using the program mux rate extracted from the pack header of the PS as follows:

$$SCR offset = \frac{pack size \times 8}{program mux rate} \times system clock , \qquad ( 1 )$$

where a pack size denotes a size of a single pack and is generally 2 Kbytes (=2048 bytes) in a storage medium such as a DVD or an HD-DVD. However, this size may vary. For example, when the program mux rate extracted from a pack header is 10.08 Mbps and a system clock is 27 MHz, an SCR offset indicating a difference between SCRs of adjacent packs of the PS is about 43885.7 seconds. In Equation (1), 8 is multiplied to convert a byte unit into a bit unit.

The TS packet generating unit 540 calculates a PES packet size using a PES packet length field included in a PES packet header. The PES packet size indicates the size of the remaining portion of a pack except for a pack header and is assigned to the payload of the TS packet. The PES packet size is calculated as follows:

PES packet size=PES packet length+2+4 (byte) (2),

where the 2 bytes is the size of a PES packet length field and the 4 bytes is a sum of the size of a pack start code prefix field and the size of a stream indicator field. In an MPEG-2 PES packet, a PES packet length field indicates the size of its following data included in the PES packet. Thus, to obtain the PES packet size to be processed, the size of the PES packet length field, the size of the packet start code prefix field, and the size of the stream indicator field should be added as in Equation (2).

The TS packet generating unit 540 divides the PES packet size by the payload size of a TS packet to obtain the number of TS packets needed for conversion of PES packets of the PS. In other words, the number of TS packets needed to convert one pack into TS packets, i.e., a TS packet count in one pack, is obtained. For example, if the PES packet size is 2034 bytes and the payload size of a TS packet is 184 bytes, a TS packet count in one pack needed for assigning PES packets included in a pack to the payload of the TS packet is 2034/184=11.05. Therefore, in this example case, at least 12 TS packets are needed for assignment of PES packets of the PS. The TS packet generating unit 540 compares the TS packet count in one pack with a number of TS packets that have been processed to check if all the PES packets included in the PS have been converted into TS packets in operation 470. If there are still PES packets to be processed, the foregoing process is repeated.

Whenever the TS packet generating unit 540 generates a TS packet, it subtracts the payload size of the TS packet from the PES packet size to be processed. If the PES packet size to be processed is smaller than the maximum payload size (184 bytes) of a TS packet after repeating TS packet generation, the TS packet generating unit 540 generates a TS packet of 188 bytes by applying stuff bytes of an adaptation field to an insufficient payload space of the TS packet.

If the format of the generated consecutive T packets should be converted into an SESF TS format, the TS packet generating unit 540 calculates a TS ATS offset indicating a time difference between the TS packets. The TS ATS offset can be calculated using the SCR offset obtained using Equation 1 and the TS packet count in one pack as follows:

$$TS ATS offset = \frac{SCR offset}{TS packet count in one pack} \qquad ( 3 )$$

For example, if the SCR offset is 43885.7 and the TS packet count in one pack is 12, the TS ATS offset is 43885.7/12=3657.14.

The SESF is used to encode an analog signal or decode a digital signal and encode the encoded analog signal or the decoded digital signal into an MPEG TS, and is usually used for data recording in a Blu-ray disc. To support an SESF TS format, a 192-byte source packet is generated by adding a 4-byte TS packet extra header in front of a general 188-byte TS packet. The 4-byte TS packet extra header includes a 2-bit copy permission indicator and a 30-bit ATS field.

The SESF TS packet generating unit 550 adds the 4-byte TS packet extra header to each TS packet output from the TS packet generating unit 540 using the TS ATS offset. If k (k is an integer) TS packets have been generated prior to a currently processed TS packet, the SESF TS packet generating unit 550 inserts a value of k×TS ATS offset into an ATS field of the TS packet extra header of the currently processed TS packet. In other words, the SESF TS packet generating unit 550 applies an ATS that is updated by addition of the TS ATS offset to the existing ATS of the TS packet to the TS packet extra header of the TS packet, thereby generating a source packet supporting the SESF TS format used in a Blu-ray disc.

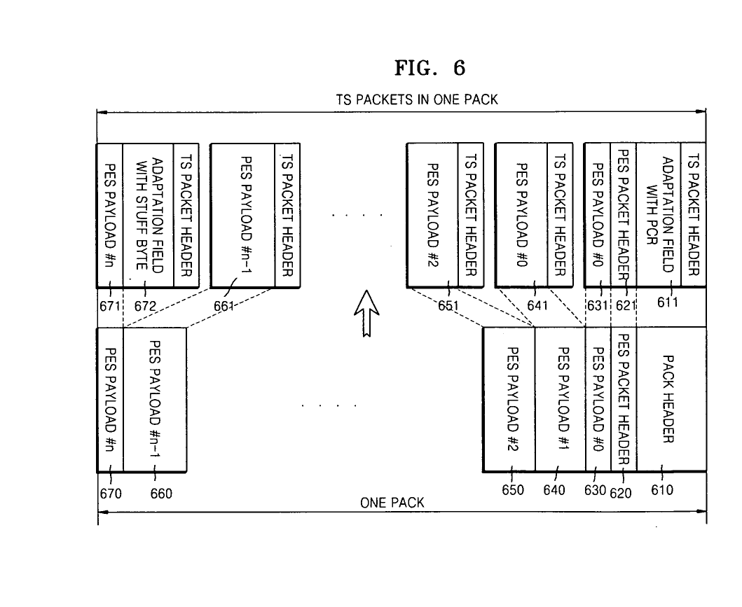

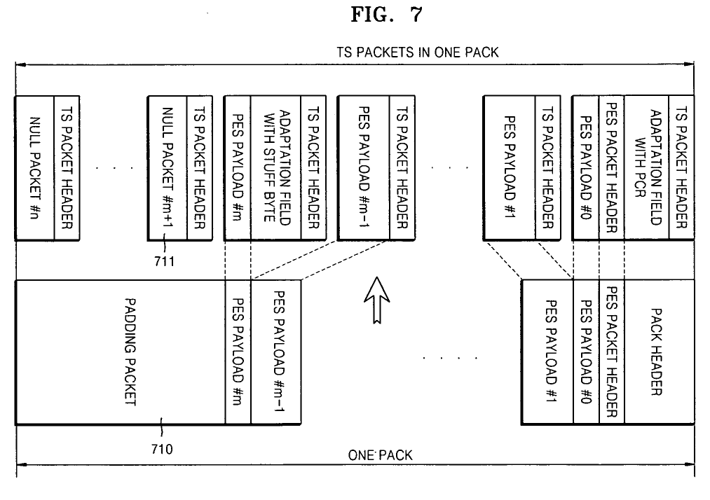

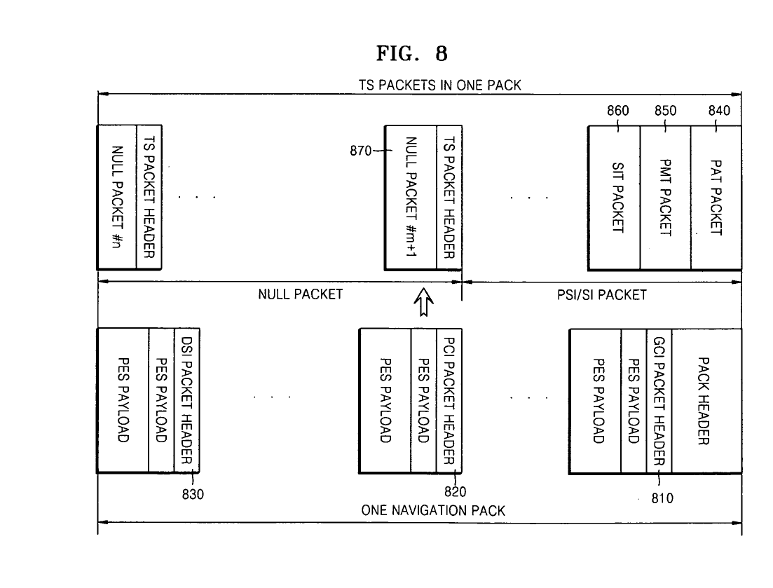

FIGS. 6 through 8 illustrate examples of conversion of a pack of a PS into TS packets according to an exemplary embodiment of the present invention. In FIG. 6, only data packets are included in one pack. In FIG. 7, only data packets and a padding packet are included in one pack. In FIG. 8, only navigation data is included in one pack.

Referring to FIG. 6, an SCR extracted from a pack header 610 of a PS is recorded in a PCR field of an adaptation field 611 of a TS packet header of a corresponding TS packet. A PES packet header 620 of the PS is inserted into a payload 621 of the TS packet and a portion 630 of PES payload data is inserted into the remaining space 631 of the payload 621 of the first TS packet. The remaining portion of the PES payload data included in the PS is divided by the payload size of a TS packet and is inserted into the payload of the TS packet. As mentioned above, a PID corresponding to a data type extracted from a stream ID of the PS is inserted into a PID field of the TS packet. By repeating the foregoing process, all the PES packets included in the PS are divided and inserted into the payloads of TS packets. If the remaining portion, i.e., PES Payload #n 670, of the PES payload data is less than 184 bytes that is the payload size of a TS packet, the remaining portion is inserted into a payload 671 of the TS packet and stuff bytes of an adaptation field are applied to an insufficient payload space of the TS packet.

Referring to FIG. 7, if a padding packet 710 is included to maintain a specific size, a null packet, e.g., null packet #m+1 711, is inserted for synchronization with a pack. The number of inserted null packets is calculated by subtracting the number of TS packets generated by PES packets, except for the null packet, from a TS packet count in one pack that denotes a number of TS packets needed for converting one pack into TS packets.

Referring to FIG. 8, if the currently processed pack of the PS is a navigation pack including a GCI packet header 810, a PCI packet header 820, and a DSI packet header 830, a PSI/SI packet is inserted, instead of processing a current PES packet, to check if processing with respect to the current pack is completed, and a null packet, e.g., null packet #m+1 870, is inserted into the remaining space for synchronization between the pack of the PS and the generated TS packet.

In an exemplary embodiment of the present invention, when a PS is converted into a TS format, the minimum TS mux rate is calculated as follows:

$$Min TS mux rate = \frac{TS packet size \times 8}{TS ATS offset} \times system clock \qquad ( 4 )$$

For example, if the TS ATS offset is 3657.14, the TS packet size is 188 bytes, and the system clock is 27 MHz, the minimum TS max rate is (188*8)*27000000/3657.14=11.1 (Mbps). The TS mux rate is higher than the program mux rate because a TS carries a larger amount of data than a PS for the same period.

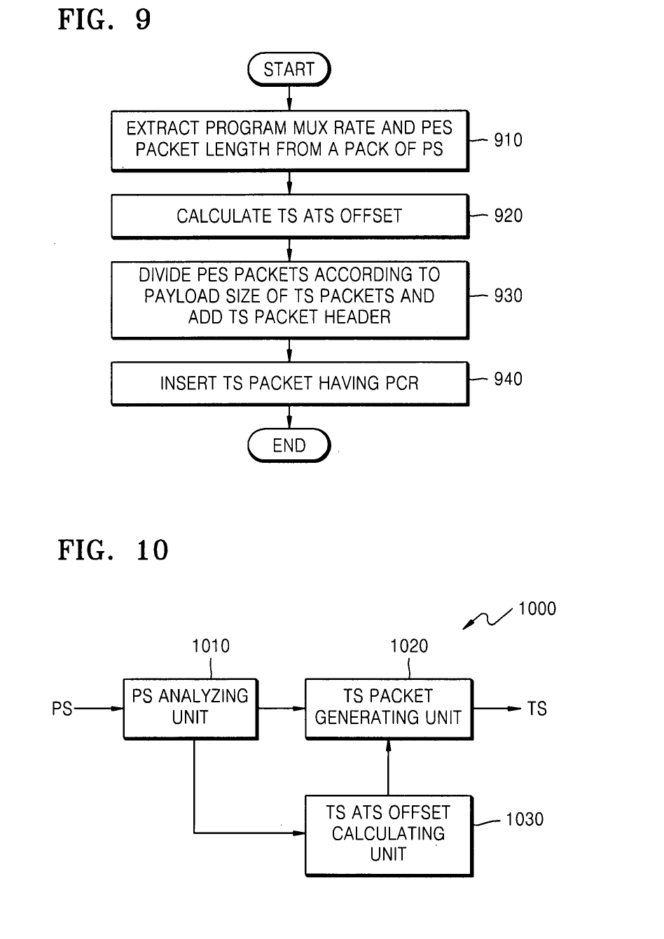

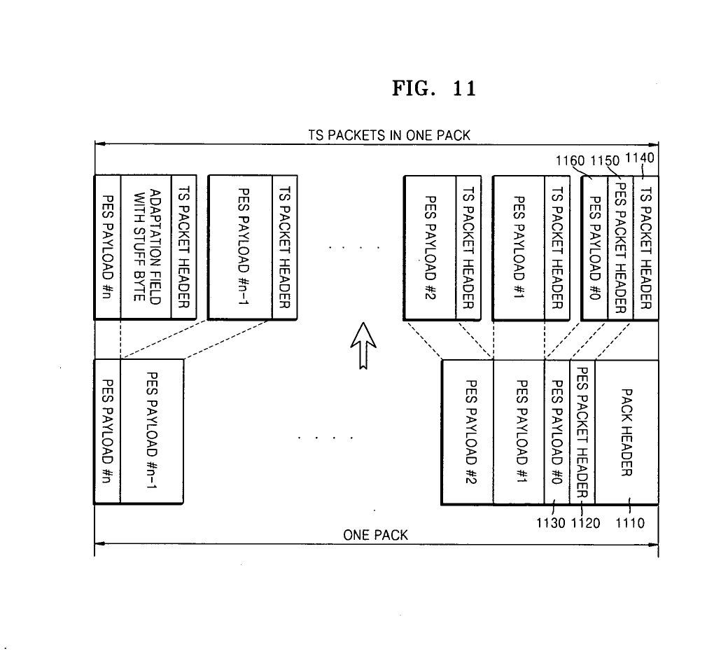

FIG. 9 is a flowchart illustrating a method of converting a data stream format according to another exemplary embodiment of the present invention, and FIG. 10 is a block diagram of an apparatus 1000 for converting a data stream format according to another exemplary embodiment of the present invention.

In another exemplary embodiment of the present invention, a PS is converted into a TS for a case where the PID of a PCR packet is specified in the format of the TS. For example, in a Blu-ray disc using the SESF TS format, the PID of the PCR packet is specified to “0x1001”. The case where the PID of the PCR packet is specified denotes that a PCR cannot be inserted into a random TS packet and only a TS packet having a specific PID can have the PCR. A PCR can be inserted into an adaptation field of a TS packet including video or audio data according to the exemplary embodiment of the present invention, but it cannot be inserted into a random TS packet according to another exemplary embodiment of the present invention and thus a separate process is used. In another exemplary embodiment of the present invention, a PCR is inserted using a TS packet substituting for a null packet inserted for synchronization between a pack of a PS and TS packets.

Referring to FIG. 10, the apparatus 1000 includes a PS analyzing unit 1010, a TS packet generating unit 1020, and a TS ATS offset calculating unit 1030.

The PS analyzing unit 1010 extracts a program mux rate from a pack header included in a pack of a PS and extracts a PES length from a PES packet header in operation 910.

To calculate a PCR inserted into a PCR packet, the TS ATS offset calculating unit 1030 calculates a TS ATS offset indicating a time difference between consecutive TS packets using the extracted program mux rate and a pack size in operation 920. More specifically, the TS ATS offset calculating unit 1030 calculates an SCR offset that is a difference between SCRs of packs included in the PS using Equation 1. The TS ATS offset calculating unit 1030 calculates a PES packet size corresponding to one pack by applying the extracted PES packet length to Equation 2 and obtains a TS packet count in one pack by dividing the calculated PES packet size by the payload size of a TS packet. The TS ATS offset calculating unit 1030 divides the SCR offset by the TS packet count in one pack, thereby calculating the TS ATS offset.

The TS packet generating unit 1020 divides PES packets included in a pack according to the payload size of a TS packet and adds a TS packet header to each of the divided PES packets, thereby generating consecutive TS packets in operation 930. A PID corresponding to the data type of each PES packet identified using a stream ID extracted from a PES packet header is assigned to a TS PID field.

According to another exemplary embodiment of the present invention, since a PID having a PCR is specified, the SCR extracted from a pack header cannot be directly applied to a PCR field of a TS packet header. Instead, a TS packet having a PCR calculated using a TS ATS offset and having a fixed PCR PID is used. In particular, a PCR packet is inserted instead of at least one of null packets inserted for a navigation pack or synchronization between a pack and TS packets. The PCR packet inserted instead of a null packet is a TS packet having a fixed PCR PID indicating that the TS packet has a PCR and having a PCR calculated from the TS ATS offset in its adaptation field. When the number of TS packets processed prior to a null packet instead of which the PCR packet is inserted is k (k is an integer), the PCR of a PCR packet in the adaptation field of the PCR packet is (k×TS ATS offset).

In order for the generated TS to support the SESF TS format, an SESF TS packet generating unit (not shown) for adding a 4-byte extra header to each TS packet may be further included in the apparatus 1000 as another exemplary embodiment of the present invention.

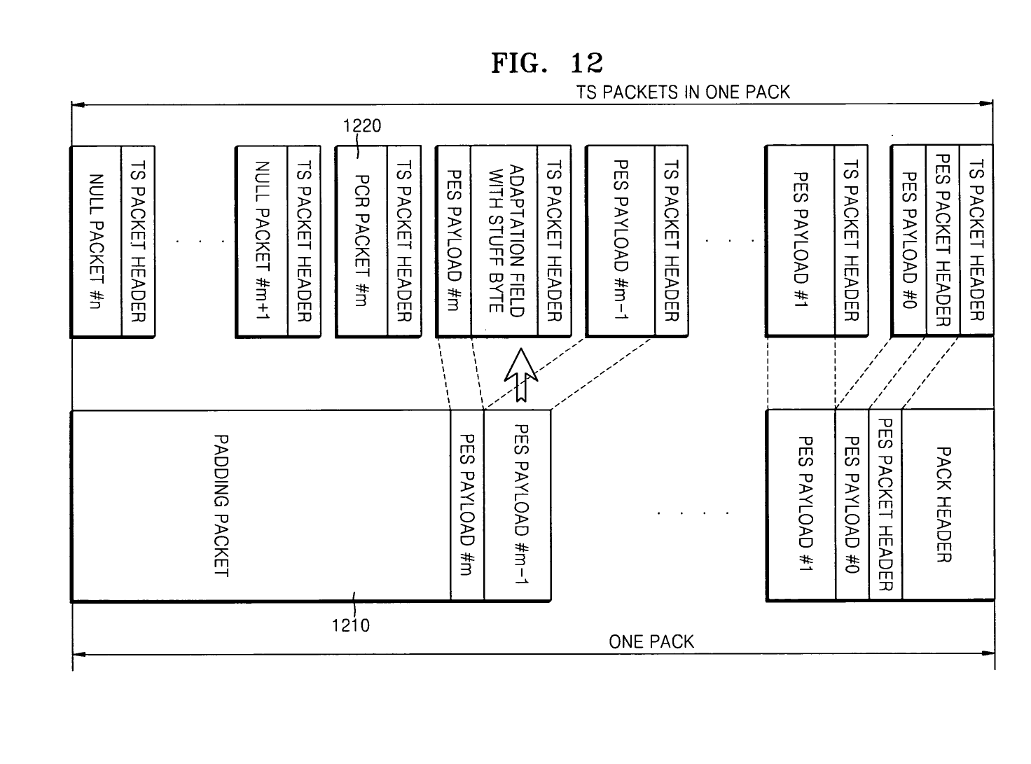

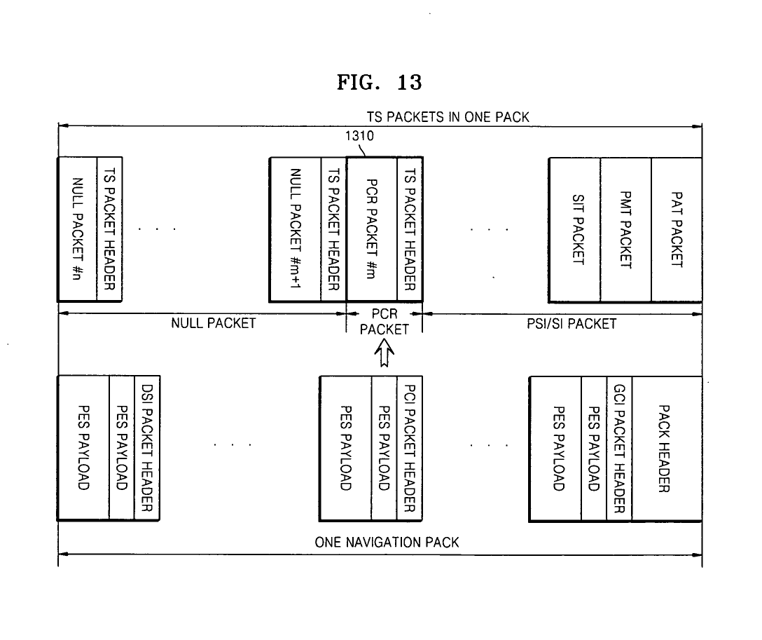

FIGS. 11 through 13 illustrate examples of conversion of a pack of a PS into TS packets according to another exemplary embodiment of the present invention. In FIG. 11, only data packets are included in one pack. In FIG. 12, only data packets and a padding packet are included in one pack. In FIG. 13, navigation data is included in one pack.

Referring to FIG. 11, since a PID having a PCR is fixed according to another exemplary embodiment of the present invention, an SCR extracted from a pack header 1110 of a PS is not used and a PCR field of an adaptation field in a TS packet header 1140 is not used. A PES packet header 1120 of the PS is inserted to a payload portion 1150 of a TS packet and a portion, i.e., PES payload #0 1130, of PES payload data is inserted into the remaining payload portion 1160 of the first TS packet. As in a previously described exemplary embodiment of the present invention, the remaining PES payload portion of the PS is divided by the payload size of a TS packet and is inserted into the payload portion of each TS packet. At this time, PTS/DTS included in the PES packet header are divided without a need for an additional process and are inserted into the payload portion of the TS packet. Since the PCR of the TS packet is calculated using the SCR within the pack, PTS/DTS in the pack header of the PS can also be directly used. As mentioned above, a PID corresponding to the data type extracted from a stream ID of the PS is inserted into the PID field of the TS packet. By repeating the foregoing process, all the PES packets included in the PS are assigned to the payload portion of the TS packet. If the size of the remaining PES packets is less than 184 bytes, which is the payload size of a TS packet, stuff bytes of the adaptation field are inserted to the insufficient payload space of the TS packet, thereby generating a TS packet of 188 bytes.

Referring to FIG. 12, if a padding packet 1210 is included to maintain a specific size, a null packet or packets are inserted into the TS for synchronization with a pack. In particular, according to another exemplary embodiment of the present invention, a PCR packet #m 1220 that is a TS packet having a fixed PCR PID and a PCR calculated using a TS ATS offset is inserted instead of at least one of the null packets inserted for synchronization between a pack and TS packets. Although a PCR packet is inserted instead of the first null packet in FIG. 12, the number of inserted PCR packets may be increased based on a PCR packet interval used by a decoder.

Referring to FIG. 13, if the currently processed pack of the PS is a navigation pack, a PSI/SI packet is inserted, instead of processing a current PES packet, to check if processing with respect to the current pack is completed, and a null packet is inserted into a remaining space to synchronize a pack of the PS and the generated TS packets. A PCR packet #m 1310 that is a TS packet having a fixed PCR PID and a PCR calculated using a TS ATS offset is inserted instead of a null packet.

The method of and apparatus for converting a data stream format can be applied to a recording apparatus for extracting data stored in a PS format in a recording medium and recording the extracted PS after converting the extracted PS into a TS. In this case, the recording apparatus may further include a reading unit that extracts a pack from data in the PS format stored in the recording medium and a recording unit that records a TS converted by the apparatus for converting a data stream format according to an exemplary embodiment of the present invention in a recording medium, in addition to the configuration of the apparatus for converting a data stream format. The recording medium may be predetermined. The recording apparatus may be used to extract data from a storage medium having data recorded thereon in a PS format, such as a HD-DVD or a DVD, convert the extracted PS into a TS, and store the converted data in a storage medium using a TS format such as a Blu-ray disc. The storage medium may be predetermined.

As described above, according to exemplary embodiments of the present invention, during conversion of a PS into a TS, demultiplexing with respect to the PS can be skipped. In other words, exemplary embodiments of the present invention skip a process of calculating time information in the TS using time information in the PS, thereby providing an efficient data stream format, and can be used in conversion of a data stream format in a recording and/or reproducing apparatus supporting both the PS and the TS formats.

The method of converting a data stream format according to exemplary embodiments of the present invention can also be embodied as a computer-readable code on a computer-readable recording medium. A computer-readable recording medium is any data storage device that can store data which can be thereafter read by a computer system. Examples of computer-readable recording media include read-only memory (ROM), random-access memory (RAM), CD-ROMs, magnetic tapes, floppy disks, optical data storage devices, and carrier waves. The computer-readable recording medium can also be distributed over a network of coupled computer systems so that the computer-readable code is stored and executed in a decentralized fashion.

While the present inventive concept has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of converting a data stream format, in which a program stream (PS) is converted into a transport stream (TS), the method comprising:
extracting a system clock reference (SCR) and a program mux rate from a pack header included in a pack of the PS;
extracting a stream identifier (ID) from a packetized elementary stream (PES) packet header included in the pack;
identifying a data type of PES packets included in the pack using the stream identifier (ID);
dividing the PES packets according to a payload size of a TS packet if the identified data type is video or audio data;
generating consecutive TS packets by adding a TS pack header to each of the divided PES packets; and
setting a program clock reference (PCR) of an adaptation field included in a TS packet header of a first generated TS packet, among the consecutive TS packets, equal to the extracted SCR.

2. The method of claim 1, wherein the dividing the PES packets comprises:
extracting PES packet length information from the PES packet header;
calculating a PES packet size for the pack using the PES packet length information; and
dividing the PES packet size by a maximum payload size of a TS packet to calculate a number of TS packets needed to convert all the PES packets included in the pack into the consecutive TS packets.

3. The method of claim 2, wherein the PES packet size is calculated by adding a packet start code and a length of the stream ID to the extracted PES packet length information.

4. The method of claim 1, wherein the generating the consecutive TS packets comprises:
calculating a remaining PES packet size by subtracting the payload size of a TS packet from a PES packet size whenever a TS packet is generated; and
inserting stuff bytes into an adaptation field of the TS packet header if the remaining PES packet size is smaller than the payload size of the TS packet.

5. The method of clam 1, wherein the generating the consecutive TS packets comprises inserting a null packet into a TS packet if a divided PES packet is a padding packet.

6. The method of claim 1, wherein the generating the consecutive TS packets comprises assigning an ID of the TS packet according to the identified data type of the PES packets.

7. The method of claim 1, further comprising substituting program specific information (PSI) packets or system information (SI) packets for navigation information of the PES packets included in the pack if the identified data type is navigation data.

8. The method of claim 1, further comprising (f) adding an extra header including a copy permission indicator and an arrival time stamp (ATS) field to each of the consecutive TS packets.

9. The method of claim 8, wherein the adding an extra header comprises:
calculating an SCR offset indicating a difference between SCRs of packs included in the PS using the extracted program mux rate, a pack size, and a system clock;
dividing the calculated SCR offset by a number of TS packets needed to convert all the PES packets included in the pack into the TS packets to calculate a TS ATS offset indicating a time difference between the TS packets; and
inserting an ATS of k×TS ATS offset into the ATS header of the extra header of a currently processed TS packet, where k is an integer and denotes a number of TS packets generated prior to a currently processed TS packet among the consecutive TS packets

10. The method of claim 9, wherein the SCR offset is expressed as
$$\frac{s \times 8}{m} \times c ,$$
where m denotes the extracted program mux rate, s denotes the pack size, and c denotes the system clock.

11. An apparatus for converting a data stream format, in which a program stream (PS) is converted into a transport stream (TS), the apparatus comprising:
a PS analyzing unit which extracts a system clock reference (SCR) and a program mux rate from a pack header included in a pack of the PS;
a packetized elementary stream (PES) packet type identifying unit which identifies a data type of PES packets included in the pack using a stream identifier (ID) extracted from a PES packet header included in the pack;
a PES packet dividing unit which divides the PES packets according to a payload size of a TS packet if the identified data type is video or audio data; and
a TS packet generating unit which generates consecutive TS packets by adding a TS pack header according to a TS format to each of the divided PES packets and sets a program clock reference (PCR) of an adaptation field included in a TS packet header of a first generated TS packet, among the consecutive TS packets, equal to the extracted SCR.

12. The apparatus of claim 11, wherein the PES packet dividing unit calculates a PES packet size for the pack using PES packet length information extracted from the PES packet header and divides the PES packet size by a maximum payload size of a TS packet to calculate a number of TS packets needed to convert all the PES packets included in the pack into the consecutive TS packets.

13. The apparatus of claim 12, wherein the PES packet size is calculated by adding a packet start code and a length of the stream ID to the extracted PES packet length information.

14. The apparatus of claim 11, wherein the TS packet generating unit calculates a remaining PES packet size by subtracting the payload size of a TS packet from a PES packet size whenever a TS packet is generated and inserts stuff bytes into an adaptation field of the TS packet header if the remaining PES packet size is smaller than the payload size of the TS packet.

15. The apparatus of clam 11, wherein the TS packet generating unit inserts a null packet into the TS packet if a divided PES packet is a padding packet.

16. The apparatus of claim 11, wherein the TS packet generating unit assigns an ID of a TS packet according to the identified data type of the PES packets.

17. The apparatus of claim 11, wherein the TS packet generating unit substitutes program specific information (PSI) packets or system information (SI) packets for navigation information of the PES packets included in the pack if the identified data type is navigation data.

18. The apparatus of claim 11, further comprising a self encode stream format (SESF) TS packet generating unit that adds an extra header including a copy permission indicator and an arrival time stamps (ATS) field to each of the consecutive TS packets.

19. The apparatus of claim 18, wherein the SESF TS packet generating unit comprises:
an SCR offset calculating unit which calculates an SCR offset indicating a difference between SCRs of packs included in the PS using the extracted program mux rate, a pack size, and a system clock;
a TS arrival time stamp (ATS) calculating unit which divides the calculated SCR offset by a number of TS packets needed to convert all the PES packets included in the pack into the TS packets to calculate a TS ATS indicating a time difference between the TS packets; and
an extra header inserting unit which inserts an ATS of k×TS ATS offset into the ATS field of the extra header of a currently processed TS packet, where k is an integer denoting a number of TS packets generated prior to a currently processed TS packet, among the consecutive TS packets.

20. The apparatus of claim 19, wherein the SCR offset is expressed as
$$\frac{s \times 8}{m} \times c ,$$
where m denotes the extracted program mux rate, s denotes the pack size, and c denotes the system clock.

21. A method of converting a data stream format, in which a program stream (PS) is converted into a transport stream (TS), the method comprising:
extracting a program mux rate from a pack header included in a pack of the PS;
calculating a TS arrival time stamp (ATS) offset indicating a time difference between TS packets using a pack size and the extracted program mux rate;
dividing PES packets included in the pack according to a payload size of a TS packet;
generating consecutive TS packets by adding a TS pack header to each of the divided PES packets; and
inserting a TS packet including a fixed program clock reference (PCR) packet identifier (PID) and a PCR calculated using the TS ATS offset, instead of a null packet inserted for synchronization between the pack and the consecutive TS packets.

22. The method of claim 21, wherein the calculating the TS ATS offset comprises:
calculating a system clock reference (SCR) offset indicating a difference between SCRs of packs included in the PS using the extracted program mux rate, the pack size, and a system clock; and
dividing the calculated SCR offset by a number of TS packets needed to convert all the PES packets included in the pack into the consecutive TS packets to calculate the TS ATS offset.

23. The method of claim 22, wherein the SCR offset is expressed as
$$\frac{s \times 8}{m} \times c ,$$
where m denotes the extracted program mux rate, s denotes the pack size, and c denotes the system clock.

24. The method of claim 21, wherein the dividing the PES packets comprises assigning an identifier (ID) to a TS packet according to a data type of the PES packets identified based on a stream ID extracted from a PES packet header.

25. The method of claim 21, wherein the PCR is (k×TS ATS offset), where k is an integer denoting a number of TS packets processed prior to a null packet instead of which the PCR packet is inserted.

26. The method of claim 21, further comprising adding a 4-byte extra header to each of the consecutive TS packets.

27. An apparatus for converting a data stream format, in which a program stream (PS) is converted into a transport stream (TS), the apparatus comprising:
a PS analyzing unit which extracts a program mux rate from a pack header included in a pack of the PS;
a TS arrival time stamp (ATS) offset calculating unit which calculates a TS ATS offset indicating a time difference between TS packets using a pack size and the extracted program mux rate; and
a TS packet generating unit which divides PES packets included in the pack according to the payload size of a TS packet, generates consecutive TS packets by adding a TS pack header to each of the divided PES packets, and inserts a TS packet including a fixed program clock reference (PCR) packet identifier (PID) and a PCR calculated using the TS ATS offset, instead of a null packet inserted for synchronization between the pack and the consecutive TS packets.

28. The apparatus of claim 27, wherein the TS packet generating unit assigns an identifier (ID) to a TS packet according to a data type of the PES packets identified based on a stream ID extracted from a PES packet header.

29. The apparatus of claim 27, wherein the TS ATS offset calculating unit calculates a system clock reference (SCR) offset indicating a difference between SCRs of packs included in the PS using the extracted program mux rate, the pack size, and a system clock, and divides the calculated SCR offset by a number of TS packets needed to convert all the PES packets included in the pack into the TS packets.

30. The apparatus of claim 29, wherein the SCR offset is expressed as
$$\frac{s \times 8}{m} \times c ,$$
where m denotes the extracted program mux rate, s denotes the pack size, and c denotes the system clock.

31. The apparatus of claim 27, wherein the PCR is k×TS ATS offset, where k is an integer denoting a number of TS packets processed prior to a null packet instead of which the PCR packet is inserted.

32. The apparatus of claim 27, further comprising a self encode stream format (SESF) TS packet generating unit which adds a 4-byte extra header to each of the consecutive TS packets.

33. A method of extracting data stored in a program stream (PS) format in a recording medium, converting the data into data in a transport stream (TS) format, and recording the TS format data, the method comprising:
extracting a pack from the data stored in the PS format in the recording medium;
extracting a system clock reference (SCR) and a program mux rate from a pack header included in the pack;
extracting a stream identifier (ID) from a packetized elementary stream (PES) packet header included in the pack;
identifying a data type of PES packets included in the pack using the stream ID;
dividing the PES packets according to a payload size of a TS packet if the identified data type is video or audio data;
generating consecutive TS packets by adding a TS pack header to each of the divided PES packets and setting a program clock reference (PCR) of an adaptation field included in a TS packet header of a first generated TS packet, among the consecutive TS packets, equal to the extracted SCR; and
recording the consecutive TS packets.

34. An apparatus for extracting data stored in a program stream (PS) format in a recording medium, converting the data into data in a transport stream (TS) format, and recording the TS format data, the apparatus comprising:
a reading unit which extracts a pack from the data stored in the PS format in the recording medium;
a PS analyzing unit which extracts a system clock reference (SCR) and a program mux rate from a pack header included in the pack;
a packetized elementary stream (PES) packet type identifying unit which identifies a data type of PES packets included in the pack using a stream identifier (ID) extracted from a PES packet header included in the pack;
a PES packet dividing unit which divides the PES packets according to a payload size of a TS packet if the identified data type is video or audio data;
a TS packet generating unit which generates consecutive TS packets by adding a TS pack header to each of the divided PES packets and sets a program clock reference (PCR) of an adaptation field included in a TS packet header of a first generated TS packet, among the consecutive TS packets, equal to the extracted SCR; and
a recording unit which records the consecutive TS packets.

35. A method of extracting data stored in a program stream (PS) format in a recording medium, converting the data into data in a transport stream (TS) format, and recording the TS format data, the method comprising:
extracting a pack from the data stored in the PS format in the recording medium;
extracting a program mux rate from a pack header included in a pack;
calculating a TS arrival time stamp (ATS) offset indicating a time difference between TS packets using a pack size and the extracted program mux rate;
dividing PES packets included in the pack according to a payload size of a TS packet;
generating consecutive TS packets by adding a TS pack header to each of the divided PES packets;
inserting a TS packet including a fixed program clock reference (PCR) packet identifier (PID) and a PCR calculated using the TS ATS offset, instead of a null packet inserted for synchronization between the pack and the consecutive TS packets; and
recording the consecutive TS packets.

36. An apparatus for extracting data stored in a program stream (PS) format in a recording medium, converting the data into data in a transport stream (TS) format, and recording the TS format data, the apparatus comprising:
a reading unit which extracts a pack from the data stored in the PS format in the recording medium;
a PS analyzing unit which extracts a program mux rate from a pack header included in a pack;
a TS arrival time stamp (ATS) offset calculating unit which calculates a TS ATS offset indicating a time difference between TS packets using a pack size and the extracted program mux rate;
a TS packet generating unit which divides PES packets included in the pack according to the payload size of a TS packet, generates consecutive TS packets by adding a TS pack header to each of the divided PES packets, and inserts a TS packet including a fixed program clock reference (PCR) packet identifier (PID) and a PCR calculated using the TS ATS offset, instead of a null packet inserted for synchronization between the pack and the consecutive TS packets; and
a recording unit which records the consecutive TS packets.
